(19) United States
(12) Patent Application Publication
(10) Pub. No.: US 2025/0113002 A1
(43) Pub. Date: Apr. 3, 2025

(54) IMAGE FORMING APPARATUS AND SCREEN TRANSITION METHOD FOR IMAGE FORMING APPARATUS

(71) Applicant: SHARP KABUSHIKI KAISHA, Sakai City (JP)

(72) Inventor: CHIKARA MATSUDA, Sakai City (JP)

(21) Appl. No.: 18/891,693

(22) Filed: Sep. 20, 2024

(30) Foreign Application Priority Data
Oct. 2, 2023 (JP) 2023-171357

(51) Int. Cl. H04N 1/00

(52) U.S. Cl. CPC H04N 1/00482; H04N 1/00416; H04N 1/00811

(57) ABSTRACT

An image forming apparatus includes one or more controllers, a display, and an operation acceptor. The one or more controllers display an operation screen set including a plurality of screens on the display. The operation screen set includes a setting screen for setting values of one or more setting items and a setting confirmation screen for displaying any of the setting items that has been changed from a predefined default value thereof. At least a portion of the setting screen has a first screen element corresponding to the setting confirmation screen. In response to operation of the first screen element through the operation acceptor, the one or more controllers transition the screen being displayed on the display from the setting screen to the setting confirmation screen.

### BACKGROUND OF THE INVENTION

### Field of the Invention

The present disclosure relates to an image forming apparatus and the like.

### Description of the Background Art

Generally, image forming apparatuses such as multi-function printers (MFPs) and multi-function peripherals have multiple functions such as copier, facsimile machine, scanner, printer, and e-mail transmission functions. Recent image forming apparatus are increasingly multifunctional and sophisticated. Consequently, settings of a number of setting items are changeable. In a recent image forming apparatus, therefore, a series of operations is often performed, which includes changing a setting from the default value thereof, confirming the changed setting, and then giving an instruction to execute a desired function. In the course of the series of operations, a conventional image forming apparatus needs to display the same screen repeatedly, complicating the operations.

In connection with the present disclosure, an image forming apparatus is known in which function setting screens each has a confirmation tab for displaying specifics of settings configured on other function setting screens, so that the specifics of the configured settings are displayed on a currently-displayed function setting screen as necessary.

In this image forming apparatus, the specifics of the configured settings are displayed on the currently-displayed function setting screen in addition to the original content of the same function setting screen. This feature makes it possible to avoid complicated operations because a screen transition for the purpose of displaying the specifics of the configured settings can be omitted, but is not suitable particularly for small-screen image forming apparatuses because the amount of information displayed on a single screen is large.

An object of the present disclosure is to provide an image forming apparatus and the like that allows for an easy transition from a setting screen to a setting confirmation screen.

### SUMMARY OF THE INVENTION

The present disclosure provides an image forming apparatus including one or more controllers, a display, and an operation acceptor. The one or more controllers display an operation screen set including a plurality of screens on the display. The operation screen set includes a setting screen for setting values of one or more setting items and a setting confirmation screen for displaying any of the setting items that has been changed from a predefined default value thereof. At least a portion of the setting screen has a first screen element corresponding to the setting confirmation screen. In response to operation of the first screen element through the operation acceptor, the one or more controllers transition the screen being displayed on the display from the setting screen to the setting confirmation screen.

The present disclosure also provides a screen transition method for an image forming apparatus. The screen transition method includes: displaying, out of an operation screen set including a setting screen for setting values of one or more setting items and a setting confirmation screen for displaying any of the setting items that has been changed from a predefined default value thereof, the setting screen that has a first screen element corresponding to the setting confirmation screen; receiving operation of the first screen element; and transitioning the screen being displayed from the setting screen to the setting confirmation screen in response to the operation being received.

According to the present disclosure, it is possible to provide an image forming apparatus and the like that allows for an easy transition from a setting screen to a setting confirmation screen.

### BRIEF DESCRIPTION OF THE DRAWINGS

FIG. 1 is a functional block diagram of an image forming apparatus according to a first embodiment of the present disclosure.

FIG. 2A shows an example of a copy basic screen (first page) displayed on a display of the image forming apparatus. FIG. 2B shows an example of a copy basic screen (third page) displayed on the display of the image forming apparatus.

FIG. 3A shows an example of an other-function screen displayed on the display of the image forming apparatus. FIG. 3B shows an example of a page aggregation screen displayed on the display of the image forming apparatus.

FIG. 4A shows an example of a hamburger menu screen displayed on the display of the image forming apparatus. FIG. 4B shows an example of a setting confirmation screen displayed on the display of the image forming apparatus.

FIG. 5 is a diagram illustrating general screen transitions in an image forming apparatus.

FIG. 6 shows an example of a page aggregation screen according to the first embodiment of the present disclosure.

FIG. 7 is a diagram illustrating screen transitions according to the first embodiment of the present disclosure.

FIG. 8 is a diagram illustrating screen transitions according to a second embodiment of the present disclosure.

FIG. 9A shows an example of an e-mail transmission basic screen (first page) according to a third embodiment of the present disclosure. FIG. 9B shows an example of an e-mail transmission basic screen (fourth page) according to the third embodiment of the present disclosure.

FIG. 10A shows an example of an other-function screen according to the third embodiment of the present disclosure. FIG. 10B shows an example of a sharpness screen according to the third embodiment of the present disclosure.

FIG. 11 shows an example of a setting confirmation screen according to the third embodiment of the present disclosure.

FIG. 12 is a diagram illustrating screen transitions according to the third embodiment of the present disclosure.

### DESCRIPTION OF THE PREFERRED EMBODIMENTS

### 1. First Embodiment

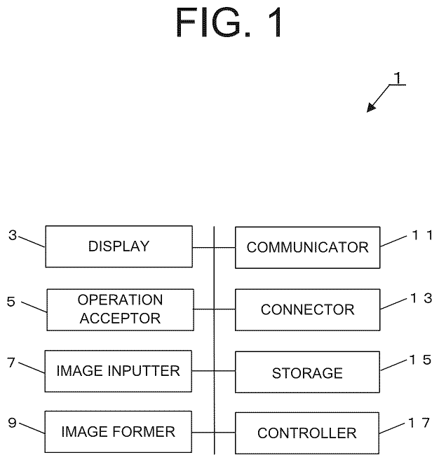

FIG. 1 is a functional block diagram of an image forming apparatus 1 according to a first embodiment of the present disclosure. The image forming apparatus 1 includes a display 3, an operation acceptor 5, an image inputter 7, an image former 9, a communicator 11, a connector 13, a storage 15, and a controller 17.

The display 3 displays images and text. For example, the display 3 includes a liquid crystal display (LCD), an organic electro-luminescence (EL) panel, or the like. The display 3 may be a single display device or may further include a display device connected to the outside.

The operation acceptor 5 accepts an operation input from a user. For example, the operation acceptor 5 includes hardware keys or software keys. The operation acceptor 5 also includes, for example, a task key for executing a task, such as FAX transmission and image reading, a stop key for stopping an operation, and the like. The operation acceptor 5 may also include physical operation keys, such as a task key, a stop key, a power key, and a power-saving key.

The image inputter 7 reads an image (document) and outputs the image as image data. The image inputter 7 includes a general scanner (image input device). Furthermore, for example, the image inputter 7 may input image data from an external storage medium such as USB memory or may receive an image via a network. The image inputter 7 is capable of executing both monochrome scanning and color scanning.

The image former 9 forms (prints) an image on a medium such as copy paper based on image data. The image former 9 may adopt any printing method. For example, the image former 9 may be any of an inkjet printer, a laser printer, and a thermal transfer printer. The image former 9 includes both a monochrome printer and a color printer. The image former 9 may include, for example, a sheet feeding mechanism that feeds media, a transport mechanism that transports media, and a sorter mechanism that sorts media on which images have been formed.

The communicator 11 connects to a network. For example, the communicator 11 includes interfaces connectable to a wired local area network (LAN), a wireless LAN, and a long term evolution (LTE) network. The image forming apparatus 1 connects to other devices or an external network through the communicator 11 connecting to a network. Alternatively or additionally, the communicator 11 may be, for example, an interface for short-range wireless communication, such as near field communication (NFC) or Bluetooth (registered trademark).

The connector 13 connects the image forming apparatus 1 to other devices. For example, the connector 13 is a USB interface to which USB memory or the like is connected. The connector 13 may be an interface other than the USB interface, such as HDMI (registered trademark) interface.

The storage 15 stores therein various types of data and various programs necessary for operation of the image forming apparatus 1. The storage 15 includes, for example, one or more recording devices capable of transitory storage, such as dynamic random access memory (DRAM), or one or more non-transitory recording devices, such as a solid state drive (SSD) including semiconductor memory or a hard disk drive (HDD) including a magnetic disc. Although a configuration including one storage 15 is described for convenience of explanation, the image forming apparatus 1 may have a configuration that includes separate devices for different purposes, such as an area (primary storage area) that is used for program execution, an area (auxiliary storage area) for storing programs and data, and a cache storage area.

The controller 17 performs overall control of the image forming apparatus 1. The controller 17 includes one or more control devices and a control circuit. For example, the controller 17 includes a central processing unit (CPU) or a system on a chip (SoC). The controller 17 can implement each function by reading a program stored in the storage 15 and executing processing.

The following describes screens to be displayed by the controller 17 on the display 3 in the image forming apparatus 1. These screens are included in an operation screen set that is displayed on the display 3 to receive input of operations to the image forming apparatus 1.

Each screen in the operation screen set has at least one screen element associated with another screen. These screen elements each correspond to a link that links screens with each other. The plurality of screens that make up the operation screen set and the links therebetween have a hierarchical structure such as a tree structure. Upon a screen element located on a screen (for example, a screen S1) and associated with another screen (for example, a screen S2) being operated through the operation acceptor 5 (for example, upon the screen element being operated using the operation acceptor 5) while the screen is displayed on the display 3, the controller 17 transitions the screen being displayed on the display 3 to the screen associated with the screen element (for example, switches the screen from the screen S1 to the screen S2).

The operation screen set includes a setting screen, a setting confirmation screen, and a selection screen. The setting screen is provided to set values of one or more setting items. The setting confirmation screen is provided to display any of the setting items that has been changed from a predetermined default value thereof. The selection screen is provided to display a plurality of screens in a selectable manner. On the selection screen, the setting screen, the setting confirmation screen, or another selection screen may be selected.

The image forming apparatus 1 has a copier function, a facsimile machine function, a scanner function, a printer function, and an e-mail transmission function. Hereinafter, these functions are referred to as main functions. The operation screen set may include a selection screen, not shown, for selecting any of the main functions. The image forming apparatus 1 may have an operation screen set having a hierarchical structure for each of the main functions. In this case, the operation screen sets of the image forming apparatus 1 as a whole include operation screen sets for the respective main functions, i.e., the copier function, the facsimile machine function, the scanner function, the printer function, and the e-mail transmission function.

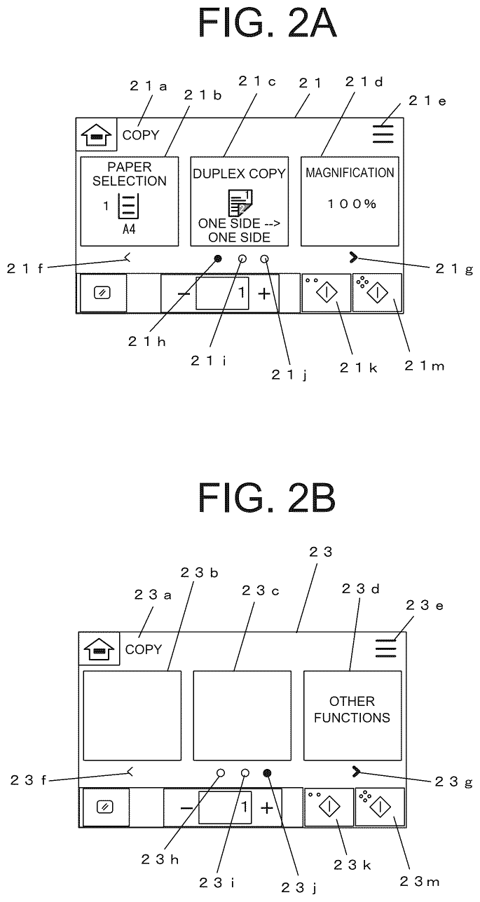

FIG. 2A shows an example of the copy basic screen (first page) displayed on the display 3 of the image forming apparatus 1. The copy basic screen 21 is the first screen to be displayed on the display 3 in the operation screen set for the copier function. The copy basic screen 21 is a selection screen and is the first page of the copy basic screen including three pages in total. The copy basic screen 21 has, as screen elements, a screen name 21a, a paper selection button 21b, a duplex copy button 21c, a magnification button 21d, a hamburger menu 21e, arrows 21f and 21g, dots 21h, 21i, and 21j, and execution buttons 21k and 21m.

The screen name 21a shows the name of the copy basic screen 21. The paper selection button 21b, the duplex copy button 21c, and the magnification button 21d are screen elements respectively associated with a paper selection screen, a duplex copy screen, and a magnification screen, not shown. Upon any of the buttons being operated through the operation acceptor 5, the controller 17 displays the screen associated with the operated button on the display 3.

The hamburger menu 21e is a screen element associated with a hamburger menu screen 29 described below. Upon the hamburger menu 21e being operated through the operation acceptor 5, the controller 17 displays the hamburger menu screen 29 on the display 3.

The arrows 21f and 21g are screen elements respectively associated with other copy basic screens that are displayed before and after the copy basic screen 21. Upon the arrow 21f being operated through the operation acceptor 5, the controller 17 displays, on the display 3, a copy basic screen 23 described below, which in other words is the third page of the copy basic screen. Upon the arrow 21g being operated through the operation acceptor 5, the controller 17 displays the second page, not shown, of the copy basic screen on the display 3.

The dots 21h, 21i, and 21j are screen elements respectively associated with the copy basic screen 21 (first page of the copy basic screen), the second page, not shown, of the copy basic screen, and the copy basic screen 23 (third page of the copy basic screen). Upon any of the dots being operated through the operation acceptor 5, the controller 17 displays the page of the copy basic screen associated with the operated dot on the display 3. In order to indicate which of the total of three pages of the copy basic screen is represented, the dot 21h is displayed as a filled black dot, and the other dots 21i and 21j are displayed as open dots on the copy basic screen 21.

The execution button 21k is a screen element associated with execution of monochrome copying. Upon the execution button 21k being operated through the operation acceptor 5, the controller 17 instructs the image former 9 to execute monochrome copying in accordance with the latest (current) settings. The execution button 21k is also referred to as a third screen element.

The execution button 21m is a screen element associated with execution of color copying. Upon the execution button 21m being operated through the operation acceptor 5, the controller 17 instructs the image former 9 to execute color copying in accordance with the latest settings. The execution button 21m is also referred to as a third screen element.

FIG. 2B shows an example of the copy basic screen (third page) displayed on the display 3 of the image forming apparatus 1. The copy basic screen 23 is also referred to as an execution instruction screen. The copy basic screen 23 is a selection screen and is the third page of the copy basic screen including three pages in total. The copy basic screen 23 has, as screen elements, a screen name 23a, buttons 23b and 23c, an other-function button 23d, a hamburger menu 23e, arrows 23f and 23g, dots 23h, 23i, and 23j, and execution buttons 23k and 23m.

The screen name 23a shows the name of the copy basic screen 23. The buttons 23b and 23c are screen elements that are each not associated with a particular screen. The other-function button 23d is a screen element associated with an other-function screen 25 described below. Upon the other-function button 23d being operated through the operation acceptor 5, the controller 17 displays the other-function screen 25 on the display 3.

The hamburger menu 23e, the arrows 23f and 23g, and the execution buttons 23k and 23m respectively have the same configurations as the hamburger menu 21e, the arrows 21f and 21g, and the execution buttons 21k and 21m. In order to indicate which of the total of three pages of the copy basic screen is represented, the dot 23j is displayed as a filled black dot, and the other dots 23h and 23i are displayed as open dots on the copy basic screen 23.

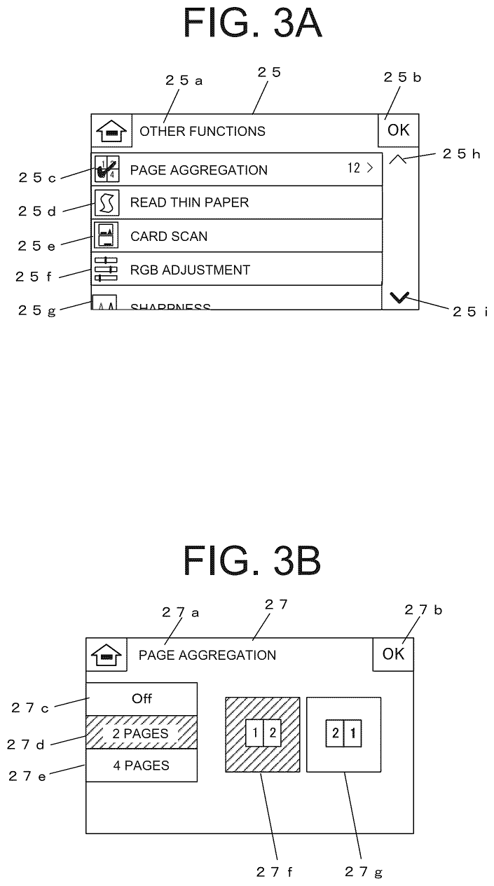

FIG. 3A shows an example of the other-function screen displayed on the display 3 of the image forming apparatus 1. The other-function screen 25 is a selection screen, and has a screen name 25a, an OK button 25b, a page aggregation button 25c, a read thin paper button 25d, a card scan button 25e, an RGB adjustment button 25f, a sharpness button 25g, and arrows 25h and 25i.

The screen name 25a shows the name of the other-function screen 25. The OK button 25b is a screen element associated with a screen one level higher than the other-function screen 25 in the hierarchical structure of the operation screen set. In the present embodiment, the OK button 25b is associated with the copy basic screen 23. The page aggregation button 25c is a screen element associated with a page aggregation screen 27 described below. The read thin paper button 25d, the card scan button 25e, the RGB adjustment button 25f, and the sharpness button 25g are screen elements respectively associated with a read thin paper screen, a card scan screen, an RGB adjustment screen, and a sharpness screen, not shown. The other-function screen 25 is a selection screen, and a main purpose thereof is to allow for selection of one of a plurality of setting screens. In FIG. 3A, the screen elements are displayed to allow for selection of one of the page aggregation screen 27, the read thin paper screen, the card scan screen, the RGB adjustment screen, and the sharpness screen. The arrows 25h and 25i are screen elements for scrolling up and down the aforementioned screen elements. Operating the arrow 25i and scrolling down the screen elements causes buttons located below the sharpness button 25g and associated with other setting screens to be displayed on the other-function screen 25.

FIG. 3B shows an example of the page aggregation screen 27 displayed on the display 3 of the image forming apparatus 1. The page aggregation screen 27 is a setting screen, and has a screen name 27a, an OK button 27b, an Off button 27c, number-of-page buttons 27d and 27e, and page arrangement buttons 27f and 27g.

The screen name 27a shows the name of the page aggregation screen 27. The OK button 27b is a screen element associated with a screen one level higher than the page aggregation screen 27 in the hierarchical structure of the operation screen set. In the present embodiment, the OK button 27b is associated with the other-function screen 25.

One of the Off button 27c and the number-of-page buttons 27d and 27e is selected by being operated through the operation acceptor 5. On the page aggregation screen 27, the Off button 27c is selected by default. As a result of the Off button 27c being selected, the page aggregation function is disabled. In a case where the number-of-page button 27d is selected, page aggregation to aggregate a two-page document into one page is performed. In a case where the page arrangement button 27g is selected, page aggregation to aggregate a four-page document into one page is performed.

One of the page arrangement buttons 27f and 27g is selected by being operated through the operation acceptor 5. The page arrangement buttons 27f and 27g are screen elements for selecting an arrangement of the aggregated pages in the document. In a case where the page arrangement button 27f is selected, the first page of the two-page document aggregated is placed on the left side of the one page and the second page is placed on the right side of the one page. In a case where the page arrangement button 27g is selected, the first page of the two-page document aggregated is placed on the right side of the one page and the second page is placed on the left side of the one page. It should be noted that the page arrangement buttons 27f and 27g are screen elements that are displayed when the number-of-page button 27d is selected, and other page arrangement buttons, not shown, for selecting an arrangement of the aggregated four pages in the document are displayed when the number-of-page button 27e is selected.

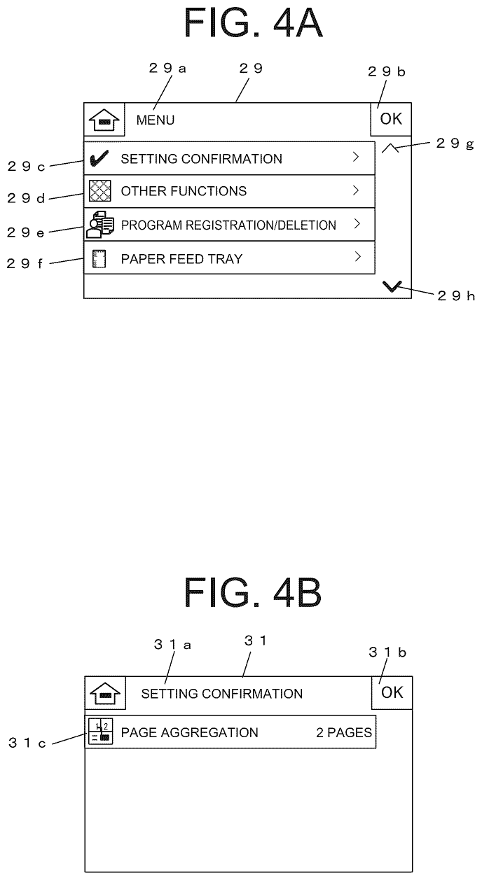

FIG. 4A shows an example of the hamburger menu screen displayed on the display 3 of the image forming apparatus 1. The hamburger menu screen 29 is a selection screen, and has a screen name 29a, an OK button 29b, a setting confirmation button 29c, an other-function button 29d, a program registration/deletion button 29e, a paper feed tray button 29f, and arrows 29g and 29h.

The screen name 29a shows the name of the hamburger menu screen 29. The OK button 29b is a screen element associated with a screen one level higher than the hamburger menu screen 29 in the hierarchical structure of the operation screen set. In the present embodiment, the OK button 29b is associated with the copy basic screen 23. The setting confirmation button 29c is a screen element associated with a setting confirmation screen 31 described below. The other-function button 29d is a screen element associated with the other-function screen 25 described below. The program registration/deletion button 29e and the paper feed tray button 29f are screen elements respectively associated with a program registration/deletion screen and a paper feed tray screen.

FIG. 4B shows an example of the setting confirmation screen displayed on the display 3 of the image forming apparatus 1. The setting confirmation screen 31 has a screen name 31a, an OK button 31b, and a page aggregation setting representation 31c. The screen name 31a shows the name of the setting confirmation screen 31. The OK button 31b is a screen element associated with a screen one level higher than the setting confirmation screen 31 in the hierarchical structure of the operation screen set. In the present embodiment, the OK button 31b is associated with the hamburger menu screen 29. The page aggregation setting representation 31c indicates that a setting has been changed from the default value thereof on the page aggregation screen 27. That is, the page aggregation setting representation 31c shown in FIG. 4B indicates that the setting has been changed from the Off button 27c being selected, which is a default value, to the number-of-page button 27d being selected (corresponding to the page aggregation setting representation 31c, “2 pages” at the right end) on the page aggregation screen 27.

Hereinafter, the position of each screen in the hierarchical structure of the operation screen set will be described. The copy basic screen 21 and the copy basic screen 23 are copy basic screens. The copy basic screens 21 and 23 are collectively referred to as Group 1. Considering the hierarchical structure of the operation screen set as a tree structure, both the other-function screen 25 and the page aggregation screen 27 can be regarded as nodes belonging to a subtree rooted at the other-function button 23d on the copy basic screen 23. Likewise, considering the hierarchical structure of the operation screen set as a tree structure, both the hamburger menu screen 29 and the setting confirmation screen 31 can be regarded as nodes belonging to a subtree rooted at the hamburger menu 23e on the copy basic screen 23. That is, the other-function screen 25 and the page aggregation screen 27 can be collectively referred to as Group 2, and the hamburger menu screen 29 and the setting confirmation screen 31 can be collectively referred to as group 3. Then, Group 2 and Group 3 belong to different subtrees.

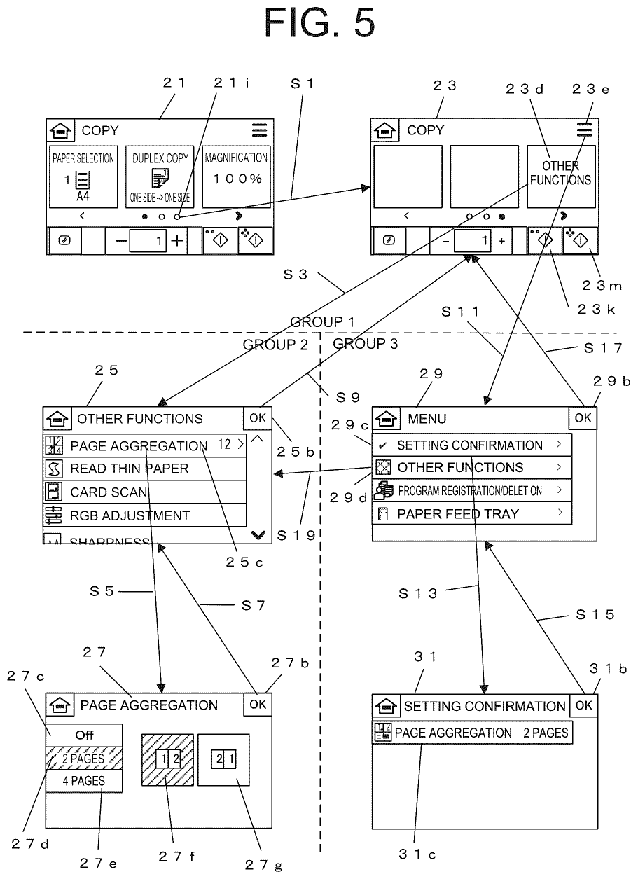

FIG. 5 is a diagram illustrating general screen transitions in an image forming apparatus. Each of arrows in FIG. 5 represents a screen transition, with the arrowhead thereof indicating a destination screen of the screen transition and the tail end thereof indicating a screen element that triggers the screen transition. In the case of the general screen transitions, the image forming apparatus 1 transitions screens along the hierarchical structure of the operation screen set. FIG. 5 shows screen transitions that start from the first page of the copy basic screen and that are required to perform a series of operations including proceeding to the page aggregation screen 27 to change settings of the page aggregation function from the default values thereof, confirming the details of the settings on the setting confirmation screen 31, and executing copying.

First, the copy basic screen (first page) 21 is displayed on the display 3. In response to operation of the dot 21i through the operation acceptor 5, the controller 17 transitions the screen being displayed on the display 3 from the copy basic screen 21 to the copy basic screen (third page) 23 (Step S1).

Next, upon the other-function button 23d being operated through the operation acceptor 5 while the copy basic screen 23 is displayed on the display 3, the controller 17 accordingly transitions the screen being displayed on the display 3 from the copy basic screen 23 to the other-function screen 25 (Step S3).

Next, upon the page aggregation button 25c being operated through the operation acceptor 5 while the other-function screen 25 is displayed on the display 3, the controller 17 accordingly transitions the screen being displayed on the display 3 from the other-function screen 25 to the page aggregation screen 27 (Step S5).

The page aggregation screen 27 is a setting screen with the Off button 27c initially selected. One of the number-of-page buttons 27d or 27e is selected by being operated through the operation acceptor 5. Upon the number-of-page button 27d being selected, the page arrangement buttons 27f and 27g corresponding to the number-of-page button 27d are displayed. The user selects one of the page arrangement buttons 27f and 27g through the operation acceptor 5. In FIG. 5, the number-of-page button 27d and the page arrangement button 27f are hatched to indicate that these buttons are in a selected state. That is, the page aggregation screen 27 in FIG. 5 shows a state resulting from the user having changed a setting on the page aggregation screen 27 from the Off button 27c, which is a default value, to aggregation of a two-page document into one page (number-of-page button 27d) in which the first page of the two aggregated pages is placed on the left and the second page is placed on the right (page arrangement button 27f).

Next, upon the OK button 27b being operated through the operation acceptor 5 while the page aggregation screen 27 resulting from the above-described setting change is displayed on the display 3, the controller 17 accordingly transitions the screen being displayed on the display 3 from the page aggregation screen 27 to the other-function screen 25 (Step S7).

Next, upon the OK button 25b being operated through the operation acceptor 5 while the other-function screen 25 is displayed on the display 3, the controller 17 accordingly transitions the screen being displayed on the display 3 from the other-function screen 25 to the copy basic screen 23 (Step S9).

Next, upon the hamburger menu 23e being operated through the operation acceptor 5 while the copy basic screen 23 is displayed on the display 3, the controller 17 accordingly transitions the screen being displayed on the display 3 from the copy basic screen 23 to the hamburger menu screen 29 (Step S11).

Next, upon the setting confirmation button 29c being operated through the operation acceptor 5 while the hamburger menu screen 29 is displayed on the display 3, the controller 17 accordingly transitions the screen being displayed on the display 3 from the hamburger menu screen 29 to the setting confirmation screen 31 (Step S13).

As described above, the setting changes to select the number-of-page button 27d and the page arrangement button 27f have been made on the page aggregation screen 27. Reflecting the setting changes, the page aggregation setting representation 31c is displayed on the setting confirmation screen 31 in FIG. 5. By seeing the page aggregation setting representation 31c, the user can confirm that page aggregation to aggregate a two-page document into one page has been set.

Next, upon the OK button 31b being operated through the operation acceptor 5 while the setting confirmation screen 31 is displayed on the display 3, the controller 17 accordingly transitions the screen being displayed on the display 3 from the setting confirmation screen 31 to the hamburger menu screen 29 (Step S15).

Next, upon the OK button 29b being operated through the operation acceptor 5 while the hamburger menu screen 29 is displayed on the display 3, the controller 17 accordingly transitions the screen being displayed on the display 3 from the hamburger menu screen 29 to the copy basic screen 23 (Step S17).

Upon the execution button 23k on the copy basic screen 23 being operated through the operation acceptor 5, the controller 17 executes monochrome copying in accordance with the details of the settings confirmed on the setting confirmation screen 31. Likewise, upon the execution button 23m being operated through the operation acceptor 5, the controller 17 executes color copying.

As described above, in a case where screen transitions are performed along the hierarchical structure of the operation screen set, a total of nine screen transitions need to be performed through Steps S1 to S17.

In order to transition the screen from the setting confirmation screen 31 to the page aggregation screen 27 along the hierarchical structure of the operation screen set, the controller 17 can perform a total of four screen transitions through Steps S15, S17, S3, and S5. Alternatively, the controller 17 may perform a total of three screen transitions through Steps S15, S19, and S5 using the other-function button 29d on the hamburger menu screen 29.

The following describes screen transitions according to the first embodiment of the present disclosure. In the case of the image forming apparatus 1 according to the present embodiment, the operation screen set having the same hierarchical structure as described above is employed, but the page aggregation screen 27 is changed to another screen. Accordingly, the screen associated with the page aggregation button 25c on the other-function screen 25 is changed. Furthermore, the screen associated with the OK button 31b on the setting confirmation screen 31 is changed. It will be apparent to those skilled in the art that the image forming apparatus 1 that performs screen transitions according to the first embodiment is also capable of operating through the screen transitions described above, in which the screens are changed along the hierarchical structure of the operation screen set.

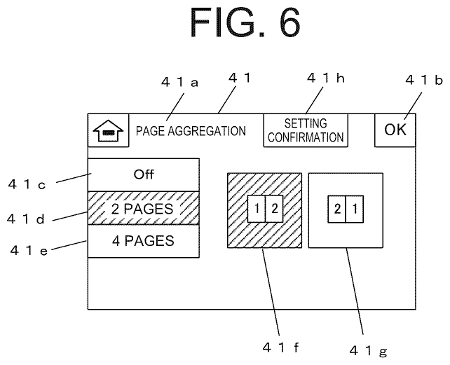

FIG. 6 shows an example of a page aggregation screen according to the first embodiment of the present disclosure. A page aggregation screen 41 is a setting screen, and has a screen name 41a, an OK button 41b, an Off button 41c, number-of-page buttons 41d and 41e, and page arrangement buttons 41f and 41g. In addition to these screen elements, the page aggregation screen 41 has a setting confirmation button 41h.

The screen name 41a, the OK button 41b, the Off button 41c, the number-of-page buttons 41d and 41e, and the page arrangement buttons 41f and 41g respectively correspond to the screen elements having the same names on the page aggregation screen 27, i.e., the screen name 27a, the OK button 27b, the Off button 27c, the number-of-page buttons 27d and 27e, and the page arrangement buttons 27f and 27g. Thus, description thereof is omitted.

The setting confirmation button 41h is a screen element associated with the setting confirmation screen 31. The setting confirmation button 41h is also referred to as a first screen element. The association between the setting confirmation button 41h and the setting confirmation screen 31 is also referred to as a first link. Upon the setting confirmation button 41h being operated through the operation acceptor 5 while the page aggregation screen 41 is displayed on the display 3, the controller 17 transitions the screen being displayed on the display 3 from the page aggregation screen 41 to the setting confirmation screen 31.

According to the change in the page aggregation screen, the screen associated with the page aggregation button 25c on the other-function screen 25 is changed from the page aggregation screen 27 to the page aggregation screen 41. Furthermore, the screen associated with the OK button 31b on the setting confirmation screen 31 is changed from the hamburger menu screen 29 to the copy basic screen 23. In this configuration, the OK button 31b is also referred to as a second screen element.

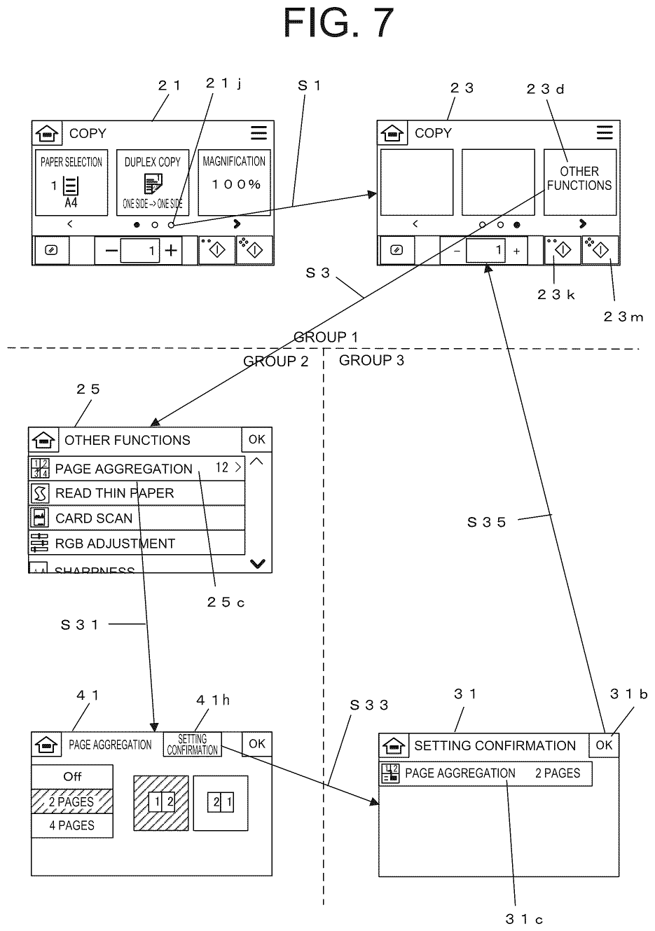

FIG. 7 is a diagram illustrating screen transitions in the image forming apparatus according to the first embodiment. Each of arrows in FIG. 7 represents a screen transition, with the arrowhead thereof indicating a destination screen of the screen transition and the tail end thereof indicating a screen element that triggers the screen transition. Like FIG. 5, FIG. 7 shows screen transitions that start from the first page of the copy basic screen and that are required to perform a series of operations including proceeding to the page aggregation screen 41 to change a setting of the page aggregation function from the default value thereof, confirming the details of the settings on the setting confirmation screen 31, and executing copying.

The screen transitions from the copy basic screen 21 to the other-function screen 25, which in other words is Steps S1 and S3, are the same as those in FIG. 5. Upon the page aggregation button 25c being operated on the other-function screen 25, the controller 17 transitions the screen being displayed on the display 3 from the other-function screen 25 to the page aggregation screen 41 (Step S31).

On the page aggregation screen 41, settings of the page aggregation function are changed through the operation acceptor 5. Thereafter, upon the setting confirmation button 41h being operated through the operation acceptor 5, the controller 17 transitions the screen being displayed on the display 3 from the page aggregation screen 41 to the setting confirmation screen 31 (Step S33).

On the setting confirmation screen 31, the page aggregation setting representation 31c is displayed, reflecting the details of the settings configured on the page aggregation screen 41. By seeing the page aggregation setting representation 31c, the user can confirm the details of the settings of the page aggregation function.

Upon the OK button 31b being operated through the operation acceptor 5 while the setting confirmation screen 31 is displayed on the display 3, the controller 17 accordingly transitions the screen being displayed on the display 3 from the setting confirmation screen 31 to the copy basic screen 23 (Step S35).

Upon the execution button 23k on the copy basic screen 23 being operated through the operation acceptor 5, the controller 17 executes monochrome copying in accordance with the details of the settings confirmed on the setting confirmation screen 31. Likewise, upon the execution button 23m being operated through the operation acceptor 5, the controller 17 executes color copying.

As the screen transitions in FIG. 7, the controller 17 performs a total of five screen transitions starting from the copy basic screen 21 through Steps S1, S3, S31, S33, and S35 in order to perform a series of operations including changing settings of the page aggregation function (page aggregation screen 41), confirming the details of the settings (setting confirmation screen 31), and executing copying (copy basic screen 23). The number of screen transitions in FIG. 7 is less than the nine screen transitions required to perform the same series of operations as shown in FIG. 5.

According to the first embodiment, a series of operations including changing settings, confirming the details of the changed settings, and executing copying in accordance with the settings can be performed with fewer operational processes, simplifying the operations.

In FIG. 4B, only the page aggregation setting representation 31c is displayed on the setting confirmation screen 31 as the details of the settings. However, this is merely an example. In a case where changing the settings on the page aggregation screen 27 is followed by changing settings from default values thereof on other setting screens (for example, setting screens, not shown, associated with the read thin paper button 25d, the card scan button 25e, the RGB adjustment button 25f, and the sharpness button 25g), it is preferable that the details of these settings be also displayed on the setting confirmation screen 31. Displaying a plurality of setting items that have been changed from the default values thereof in a list form on the setting confirmation screen 31 allows the user to grasp at once the details of the settings that have been changed from the default values thereof.

In the first embodiment, the OK button 31b on the setting confirmation screen 31 is associated with the copy basic screen 23 instead of the hamburger menu screen 29. However, the OK button 31b may be associated with the hamburger menu screen 29 as in the general case, and a screen element that is different from the OK button 31b and that is associated with the copy basic screen 23 may be provided on the setting confirmation screen 31.

Furthermore, the page aggregation screen 41 in the first embodiment has been described as always having the setting confirmation button 41h, but the present disclosure is not limited as such. For example, a setting screen such as the page aggregation screen 41 may be configured to display the setting confirmation button 41h upon a setting item that is set using the setting screen being changed from the default value thereof.

### 2. Second Embodiment

The following describes a second embodiment of the present disclosure. In the case of screen transitions according to the second embodiment, operations to be performed when any of settings being confirmed needs to be changed are simplified. The following description will only focus on differences in configuration and processes between the first embodiment and the second embodiment.

As in the first embodiment, screen transitions according to the second embodiment are performed using the copy basic screens 21 and 23, the other-function screen 25, the page aggregation screen 41, and the setting confirmation screen 31. However, the second embodiment is different from the first embodiment in the page aggregation setting representation 31c on the setting confirmation screen 31.

In the first embodiment, the page aggregation setting representation 31c is a screen element that shows the details of the settings configured on the page aggregation screen 41. By contrast, the second embodiment is different from the first embodiment in that the page aggregation setting representation 31c is associated with a setting screen for changing the settings shown therein, which in other words is the page aggregation screen 41, in addition to displaying the details of the settings. The page aggregation setting representation 31c of the second embodiment is also referred to below as a page aggregation setting representation button 31c in order to be distinguished from the page aggregation setting representation 31c of the first embodiment. The page aggregation setting representation button 31c is also referred to as a fourth screen element.

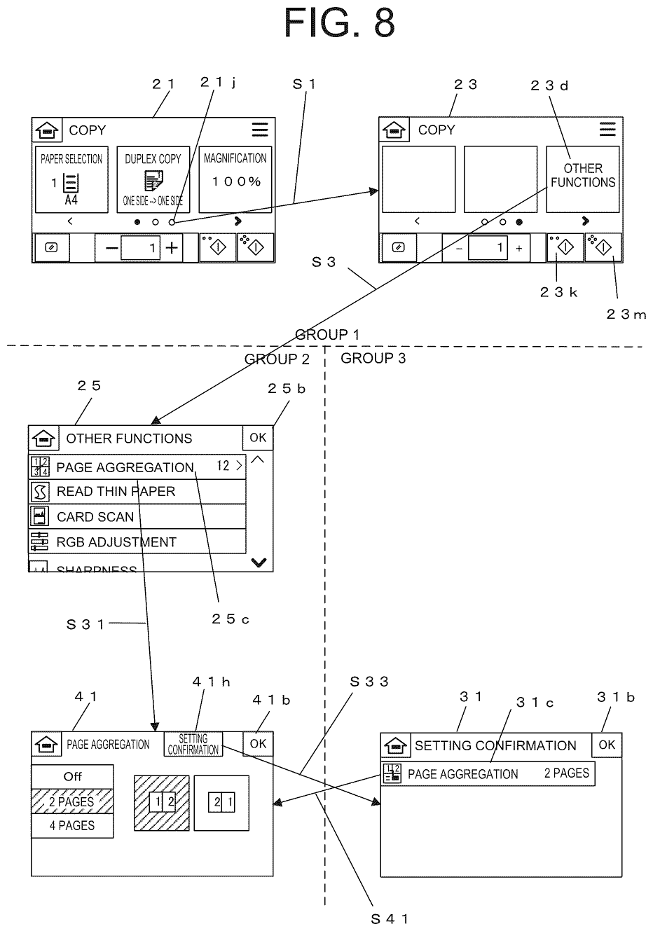

FIG. 8 is a diagram illustrating the screen transitions according to the second embodiment. Screen transitions (Steps S1, S3, S31, and S33) from the copy basic screen 21 to the setting confirmation screen 31 via the copy basic screen 23, the other-function screen 25, and the page aggregation screen 41 are the same as those in the first embodiment, and thus description thereof is omitted.

Suppose that the user referring to what is shown in the page aggregation setting representation button 31c on the setting confirmation screen 31 has determined that a setting of the page aggregation function needs to be changed. In this case, the user operates the page aggregation setting representation button 31c through the operation acceptor 5. In response to this operation, the controller 17 transitions the screen being displayed on the display 3 from the setting confirmation screen 31 to the page aggregation screen 41 associated with the page aggregation setting representation button 31c (Step S41). Once the page aggregation screen 41 is displayed, the user can change the setting as appropriate through the operation acceptor 5. An operation button, not shown, for a direct transition to the copy basic screen 23 may be displayed on the page aggregation screen 41 displayed through a transition from the setting confirmation screen 31. Upon the user operating this button through the operation acceptor 5, the controller 17 accordingly transitions the screen being displayed on the display 3 from the page aggregation screen 41 to the copy basic screen 23. Once the copy basic screen 23 is displayed, the user operates the execution button 23k or 23m through the operation acceptor 5. Based on this operation, the controller 17 executes monochrome copying or color copying in accordance with the details of the settings confirmed on the setting confirmation screen 31. The transition from the page aggregation screen 41 to the copy basic screen 23 may be performed via the setting confirmation screen 31 or via the other-function screen 25.

According to the second embodiment, when the user determines that any of the settings should be changed on the setting confirmation screen 31, the user can proceed to the page aggregation screen 41 corresponding to the settings with only one screen transition. Without the page aggregation setting representation button 31c, the user needs to go through a total of four screen transitions to reach the page aggregation screen 41 via the hamburger menu screen 29, the copy basic screen 23, and the other-function screen 25 along the hierarchical structure of the operation screen set, or a total of three screen transitions to reach the page aggregation screen 41 via the hamburger menu screen 29 and the other-function screen 25 by operating the other-function button 29d on the hamburger menu screen 29.

### 3. Third Embodiment

The following describes a third embodiment of the present disclosure. The third embodiment relates to screen transitions in an operation screen set for an e-mail transmission function. The following description will only focus on differences in configuration and processes between the first embodiment and the third embodiment.

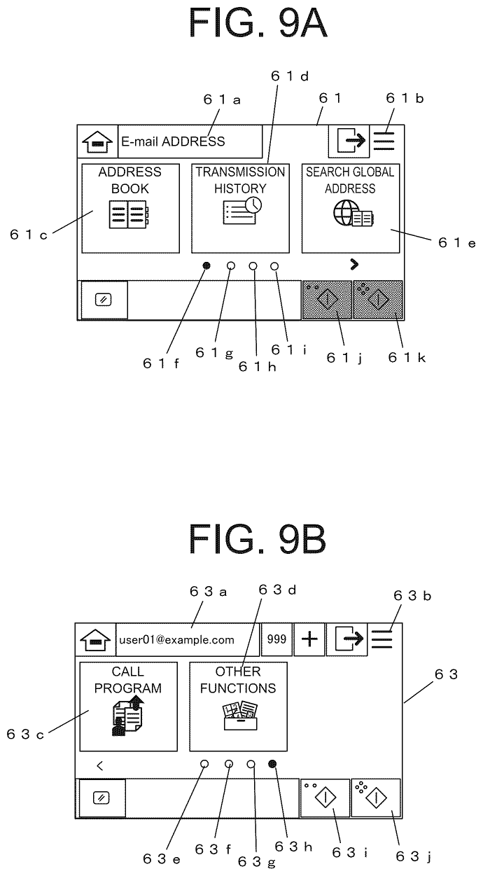

FIG. 9A shows an example of an e-mail transmission basic screen (first page) displayed on the display 3 of the image forming apparatus 1. An e-mail transmission basic screen 61 is the first screen to be displayed on the display 3 in the operation screen set for the e-mail transmission function. The e-mail transmission basic screen 61 is a selection screen and is the first page of the e-mail transmission basic screen including four pages in total. The e-mail transmission basic screen 61 includes, as screen elements, an address input field 61a, a hamburger menu 61b, an address book button 61c, a transmission history button 61d, a search global address button 61e, dots 61f, 61g, 61h, and 61i, and execution buttons 61j and 61k.

The address input field 61a is provided to input a destination address of an e-mail. On the e-mail transmission basic screen 61, the address has not been entered in the address input field 61a. The hamburger menu 61b is a screen element associated with a hamburger menu screen, not shown. The address book button 61c, the transmission history button 61d, and the search global address button 61e are screen elements respectively associated with an address book screen, a transmission history screen, and a search global address screen, not shown.

The dot 61f is a screen element associated with the e-mail transmission basic screen 61, which is the first page of the e-mail transmission basic screen. The dots 61g and 61h are screen elements respectively associated with the second page and the third page, not shown, of the e-mail transmission basic screen. The dot 61i is a screen element associated with an e-mail transmission basic screen 63 described below, which is the fourth page of the e-mail transmission basic screen. In order to indicate which of the total of four pages of the e-mail transmission basic screen is represented, the dot 61f is displayed as a filled black dot, and the other dots 61g, 61h, and 61i are displayed as open dots on the e-mail transmission basic screen 61.

The execution button 61j is a screen element associated with execution of monochrome scanning. The execution button 61k is a screen element associated with execution of color scanning. On the e-mail transmission basic screen 61, the address has not been entered in the address input field 61a. In order to prevent omission of the address entry, both the execution buttons 61j and 61k are configured not to accept any operation on the e-mail transmission basic screen 61. To indicate such configuration, the execution buttons 61j and 61k are grayed out. The execution buttons 61j and 61k are each also referred to as a third screen element.

FIG. 9B shows an example of the e-mail transmission basic screen (fourth page) displayed on the display 3 of the image forming apparatus 1. The e-mail transmission basic screen 63 is a selection screen and is the fourth page of the e-mail transmission basic screen including four pages in total. The e-mail transmission basic screen 63 has, as screen elements, an address input field 63a, a hamburger menu 63b, a call program button 63c, an other-function button 63d, dots 63e, 63f, 63g, and 63h, and execution buttons 63i and 63j.

The address input field 63a is provided to input a destination address of an e-mail. A destination address “user01@example.com” has been entered in the address input field 63a. The hamburger menu 63b is a screen element associated with a hamburger menu screen, not shown. The call program button 63c is a screen element associated with a call program screen, not shown. The other-function button 63d is a screen element associated with an other-function screen 65 described below.

The dot 63e is a screen element associated with the e-mail transmission basic screen 61, which is the first page of the e-mail transmission basic screen. The dots 63f and 63g are screen elements respectively associated with the second page and the third page, not shown, of the e-mail transmission basic screen. The dot 63h is a screen element associated with the e-mail transmission basic screen 63, which is the fourth page of the e-mail transmission basic screen. In order to indicate which of the total of four pages of the e-mail transmission basic screen is represented, the dot 63h is displayed as a filled black dot, and the other dots 63e, 63f, and 63g are displayed as open dots on the e-mail transmission basic screen 63.

The execution button 63i is a screen element associated with execution of monochrome scanning. The execution button 63j is a screen element associated with execution of color scanning. On the e-mail transmission basic screen 63, the address has been entered in the address input field 63a. Unlike the execution buttons 61j and 61k on the e-mail transmission basic screen 61, therefore, the execution buttons 63i and 63j are ready to accept operation and are not grayed out. Upon the execution button 63i being operated through the operation acceptor 5, the controller 17 accordingly causes the image inputter 7 to execute monochrome scanning in accordance with the latest settings. Upon the execution button 63j being operated through the operation acceptor 5, the controller 17 accordingly causes the image inputter 7 to execute color scanning in accordance with the latest settings.

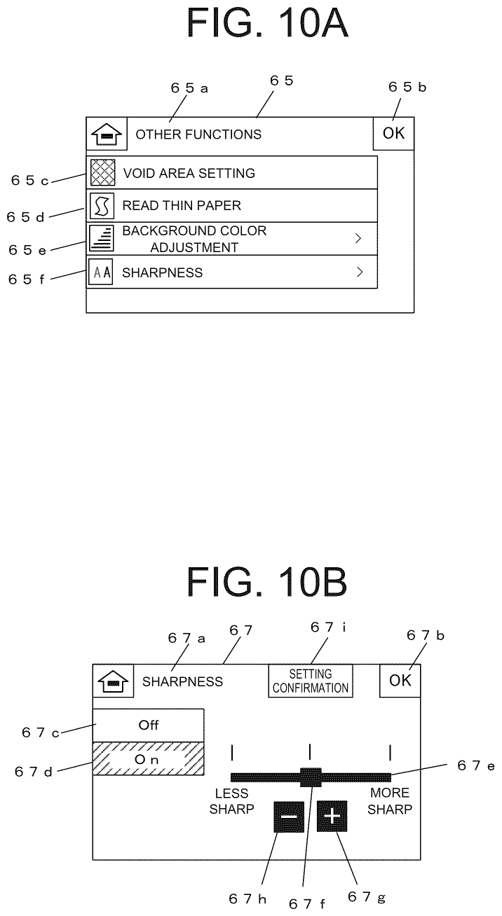

FIG. 10A shows an example of the other-function screen displayed on the display 3 of the image forming apparatus 1. The other-function screen 65 is a selection screen, and has a screen name 65a, an OK button 65b, a void area setting button 65c, a read thin paper button 65d, a background color adjustment button 65e, and a sharpness button 65f.

The screen name 65a shows the name of the other-function screen 65. The OK button 65b is a screen element associated with a screen one level higher than the other-function screen 65 in the hierarchical structure of the operation screen set. In the present embodiment, the OK button 65b is associated with the e-mail transmission basic screen 63. The void area setting button 65c, the read thin paper button 65d, and the background color adjustment button 65e are screen elements respectively associated with a void area setting screen, a read thin paper screen, and a background color adjustment screen, not shown. The sharpness button 65f is a screen element associated with a sharpness screen 67 described below. The other-function screen 65 is a selection screen, and a main purpose thereof is to allow for selection of one of a plurality of setting screens. In FIG. 10A, the screen elements are displayed to allow for selection of one of the void area setting screen, the read thin paper screen, the background color adjustment screen, and the sharpness screen 67.

FIG. 10B shows an example of the sharpness screen displayed on the display 3 of the image forming apparatus 1. The sharpness screen 67 is a setting screen, and has a screen name 67a, an OK button 67b, an Off button 67c, an On button 67d, a bar 67e, a slider 67f, a plus button 67g, a minus button 67h, and a setting confirmation button 67i.

The screen name 67a shows the name of the sharpness screen 67. The OK button 67b is a screen element associated with a screen one level higher than the sharpness screen 67 in the hierarchical structure of the operation screen set. In the present embodiment, the OK button 67b is associated with the other-function screen 65.

The Off button 67c and the On button 67d are screen elements, and one of these buttons is selected through the operation acceptor 5. The Off button 67c is a screen element associated with turning off a sharpness function. Upon the Off button 67c being selected, the controller 17 turns off the sharpness function. Upon the On button 67d being selected, the controller 17 turns on the sharpness function in accordance with the intensity of the sharpness function, which is set using the position of the slider 67f on the bar 67e. When the sharpness function is on, the controller 17 performs a sharpness process at an intensity indicated by the slider 67f on an image inputted via the image inputter 7.

The bar 67e and the slider 67f indicate the intensity at which the sharpness process is performed when the sharpness function is on. As the slider 67f is adjusted toward the left on the bar 67e, the intensity of the sharpness process decreases. As the slider 67f is adjusted toward the right on the bar 67e, the intensity of the sharpness process increases. The plus button 67g and the minus button 67h are used to finely adjust the position of the slider 67f on the bar 67e. Operating the plus button 67g causes the slider 67f to slightly move to the right on the bar 67e at a time, and operating the minus button 67h causes the slider 67f to slightly move to the left on bar 67e at a time.

The setting confirmation button 67i is a screen element associated with a setting confirmation screen 69 described below. Upon the setting confirmation button 67i being operated through the operation acceptor 5, the controller 17 accordingly transitions the screen being displayed on the display 3 from the sharpness screen 67 to the setting confirmation screen 69. The setting confirmation button 67i is also referred to as a first screen element. The association between the setting confirmation button 67i and the setting confirmation screen 69 is also referred to as a first link.

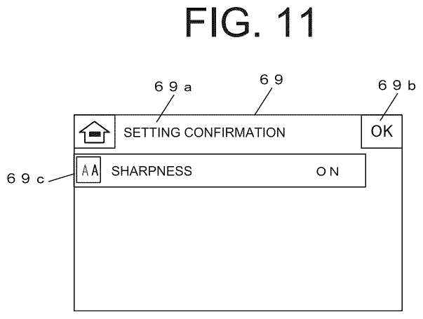

FIG. 11 shows an example of the setting confirmation screen displayed on the display 3 of the image forming apparatus 1. The setting confirmation screen 69 has a screen name 69a, an OK button 69b, and a sharpness setting representation button 69c. The screen name 69a shows the name of the setting confirmation screen 69. The OK button 69b is a screen element associated with the e-mail transmission basic screen 63. The OK button 69b is also referred to as a second screen element.

The sharpness setting representation button 69c indicates that a setting has been changed from the default value thereof on the sharpness screen 67. That is, the sharpness setting representation button 69c shown in FIG. 11 indicates that the setting has been changed from the Off button 67c being selected, which is a default value, to the On button 67d being selected on the sharpness screen 67.

The sharpness setting representation button 69c is a screen element associated with a setting screen for changing the settings shown therein, which in other words is the sharpness screen 67. In order to change the settings shown in the sharpness setting representation button 69c, the sharpness setting representation button 69c is operated through the operation acceptor 5. In response to this operation, the controller 17 transitions the screen being displayed on the display 3 from the setting confirmation screen 69 to the sharpness screen 67. According to this configuration, when the user is to change any of the settings shown in the sharpness setting representation button 69c, the user can display the sharpness screen 67, which allows the settings to be changed, with only one screen transition by operating the sharpness setting representation button 69c.

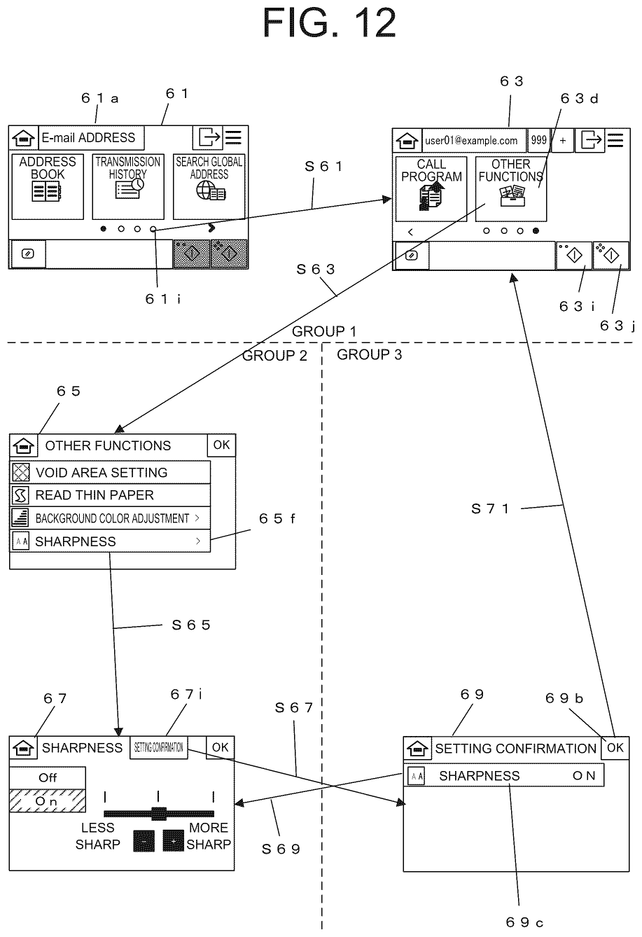

FIG. 12 is a diagram illustrating the screen transitions according to the third embodiment of the present disclosure. First, the e-mail transmission basic screen 61 is displayed on the display 3. Then, the address input field 61a receives entry of an address through the operation acceptor 5. In response to the dot 61i being operated through the operation acceptor 5, the controller 17 transitions the screen being displayed on the display 3 from the e-mail transmission basic screen 61 to the e-mail transmission basic screen (fourth page) 63 (Step S61).

Next, upon the other-function button 63d being operated through the operation acceptor 5 while the e-mail transmission basic screen 63 is displayed on the display 3, the controller 17 accordingly transitions the screen being displayed on the display 3 from the e-mail transmission basic screen 63 to the other-function screen 65 (Step S63).

Upon the sharpness button 65f being operated on the other-function screen 65, the controller 17 transitions the screen being displayed on the display 3 from the other-function screen 65 to the sharpness screen 67 (Step S65).

On the sharpness screen 67, settings of the sharpness function are changed through the operation acceptor 5. Thereafter, upon the setting confirmation button 67i being operated through the operation acceptor 5, the controller 17 transitions the screen being displayed on the display 3 from the sharpness screen 67 to the setting confirmation screen 69 (Step S67).

On the setting confirmation screen 69, the sharpness setting representation button 69c is displayed, reflecting the settings configured on the sharpness screen 67. By seeing the sharpness setting representation button 69c, the user can confirm the details of the settings of the sharpness function.

To change any of the settings, the user operates the sharpness setting representation button 69c through the operation acceptor 5. In response to this operation, the controller 17 transitions the screen being displayed on the display 3 from the setting confirmation screen 69 to the sharpness screen 67 (Step S69). An operation button, not shown, for a direct transition to the e-mail transmission basic screen 63 may be displayed on the sharpness screen 67 displayed through a transition from the setting confirmation screen 69. Upon the user operating this button through the operation acceptor 5, the controller 17 accordingly transitions the screen being displayed on the display 3 from the sharpness screen 67 to the e-mail transmission basic screen 63. Once the e-mail transmission basic screen 63 is displayed, the user operates the execution button 63i or 63j through the operation acceptor 5. Based on this operation, the controller 17 executes monochrome scanning or color scanning in accordance with the details of the settings confirmed on the setting confirmation screen 69. The transition from the sharpness screen 67 to the e-mail transmission basic screen 63 may be performed via the setting confirmation screen 69 or via the other-function screen 65.

If none of the settings needs to be changed, the user operates the OK button 69b through the operation acceptor 5. In response to this operation, the controller 17 transitions the screen being displayed on the display 3 from the setting confirmation screen 69 to the e-mail transmission basic screen 63 (Step S71).

Upon the execution button 63i on the e-mail transmission basic screen 63 being operated through the operation acceptor 5, the controller 17 executes monochrome scanning and generates monochrome image data by controlling the image inputter 7 in accordance with the details of the settings confirmed on the setting confirmation screen 69. The controller 17 then generates an e-mail with the generated monochrome image data attached thereto and transmits the e-mail to a network, not shown, through the communicator 11 using the address entered in the address input field 61a as the destination address. Upon the execution button 63j on the e-mail transmission basic screen 63 being operated through the operation acceptor 5, color scanning is executed, so that color image data is generated, attached to an e-mail, and transmitted to the destination address.

According to the third embodiment, the user operates the setting confirmation button 67i for a screen transition to the setting confirmation screen 69 after configuring the settings on the sharpness screen 67. Thus, the user can confirm the details of the settings without going through other screens.

According to the third embodiment, if any of the settings being confirmed on the setting confirmation screen 69 needs to be changed, the user operates the sharpness setting representation button 69c for a screen transition to the sharpness screen 67. Thus, the user can change the setting without going through other screens.

According to the third embodiment, if none of the settings being confirmed on the setting confirmation screen 69 needs to be changed, the user operates the OK button 69b for a screen transition to the e-mail transmission basic screen 63. Thus, the user can operate the execution button 63i or 63j without going through other screens.

### 4. Modification Example

The present disclosure is not limited to the embodiments and variations described above, and various modifications may be made thereto. That is, the technical scope of the present disclosure also includes embodiments that may be obtained by combining technical measures that are modified as appropriate without departing from the gist of the present disclosure.

The program(s) that operates on each device (apparatus) in the foregoing embodiments is a program that controls the CPU or the like (program that causes a computer to function) so as to implement the functions according to the foregoing embodiments. Information that is handled by each device (apparatus) is temporarily accumulated in a temporary storage device (for example, RAM)) during processing, is then stored in various storage devices such as read only memory (ROM) and an HDD, and is read, corrected, and written by the CPU as needed.

A recording medium that stores the program as referred to herein may be, for example, any of a semiconductor medium (for example, ROM and a non-volatile memory card), an optical recording medium/magneto-optical recording medium (for example, Digital Versatile Disc (DVD)), a Magneto Optical Disk (MO), a Mini Disc (MD), a Compact Disc (CD), and a Blu-ray (registered trademark) Disc (BD)), and a magnetic recording medium (for example, a magnetic tape and a flexible disk). Furthermore, not only are the functions of the foregoing embodiments implemented through execution of the loaded program, but the functions of the present disclosure may also be implemented through processing performed in cooperation with, for example, an operating system or other application programs based on instructions of the program.

For market distribution, the program may be stored and distributed in a portable recording medium or transferred to a server computer connected via a network such as the Internet. In this case, a storage device of the server computer is obviously included in the present disclosure.

What is claimed is:

1. An image forming apparatus comprising:
one or more controllers;
a display; and
an operation acceptor, wherein
the one or more controllers display an operation screen set including a plurality of screens on the display,
the operation screen set includes a setting screen for setting values of one or more setting items and a setting confirmation screen for displaying any of the setting items that has been changed from a predefined default value thereof,
at least a portion of the setting screen has a first screen element corresponding to the setting confirmation screen, and
in response to operation of the first screen element through the operation acceptor, the one or more controllers transition the screen being displayed on the display from the setting screen to the setting confirmation screen.

2. The image forming apparatus according to claim 1, wherein
each of the plurality of screens has a screen element corresponding to another screen,
the plurality of screens in the operation screen set and links associating the screens with each other by the screen elements have a hierarchical structure, and
a screen transition between the setting screen and the setting confirmation screen along the hierarchical structure involves at least one other screen therebetween.

3. The image forming apparatus according to claim 1, wherein
the setting confirmation screen includes a second screen element corresponding to an execution instruction screen, and
the execution instruction screen includes a third screen element corresponding to execution of a function of the image forming apparatus in accordance with the current settings.

4. The image forming apparatus according to claim 1, wherein the setting confirmation screen includes a fourth screen element corresponding to the setting screen for setting the value of the setting item that has been changed.

5. A screen transition method for an image forming apparatus, the screen transition method comprising:
displaying, out of an operation screen set including a setting screen for setting values of one or more setting items and a setting confirmation screen for displaying any of the setting items that has been changed from a predefined default value thereof, the setting screen that has a first screen element corresponding to the setting confirmation screen;
receiving operation of the first screen element; and
transitioning the screen being displayed from the setting screen to the setting confirmation screen in response to the operation being received.
